(19) United States
(12) Patent Application Publication
(10) Pub. No.: US 2005/0104037 A1
(43) Pub. Date: May 19, 2005

(54) Two-phase film materials and method for making

(76) Inventors: Pavel I. Lazarev, Belmont, CA (US); Elena N. Sidorenko, Moscow (RU)

Correspondence Address: DORSEY & WHITNEY LLP;INTELLECTUAL PROPERTY DEPARTMENT, 4 EMBARCADERO CENTER, SUITE 3400, SAN FRANCISCO, CA, 94111, US

(21) Appl. No.: 10/946,850

(22) Filed: Sep. 21, 2004

Related U.S. Application Data
(60) Provisional application No. 60/505,467, filed on Sep. 23, 2003.

(51) Int. Cl. C09K 19/00; G02F 1/1333

(52) U.S. Cl. 252/299.01; 428/1.1

(57) ABSTRACT

Two-phase film materials and methods for their fabrication are provided. The two-phase film materials typically comprise a first phase, comprising a crystalline film of supramolecules and a second phase, comprising a polymer film. The method of fabricating two-phase film materials comprise the steps of preparing a lyotropic liquid crystal of supramolecules comprising molecules of organic compound comprising at least one polar group; depositing a layer of the lyotropic liquid crystal; applying an external orienting action to the LLC layer; and treating the LCC layer with a binding agent.

### CROSS REFERENCE TO RELATED APPLICATION

This application claims the benefit of, and priority to, U.S. provisional patent application Ser. No. 60/505,467, filed on Sep. 23, 2003, entitled “Two-Phase Film Materials and Method for Making,” the entire disclosure of which is incorporated herein by reference.

### FIELD OF THE INVENTION

The present invention relates to methods and compositions for fabricating a two-phase film material. In particular, methods and compositions for fabricating anisotropic crystalline films are provided for, but not limited to, microelectronics, optics, communications, or computer technology.

### BACKGROUND OF THE INVENTION

One possible way of modifying optical materials based on crystalline films is to impart high mechanical properties to these films through interaction with high-molecular-mass compounds such as polymers.

Film materials based on polymer-dye systems are well known. Such systems are widely used as polarizing films. In particular, semicrystalline atactic poly(vinyl alcohol) (PVA) with iodine are well known. These films possess high optical properties and are used in thin-film transistor/liquid crystal displays and high-precision optical devices, see, e.g., Ed. by B. Bahadur, “Liquid Crystals—Application and Uses”, vol. 1, World Scientific, Singapore, New York, July (1990), p. 101. The choice of the optically active component in these films are generally limited by the dichroism of the polymer-dye system used. However, since polyiodine molecules exhibit much higher dichroism than other dyes, PVA—dye systems are useful as polarizing films. Disadvantageously, PVA—iodine polarizing films and systems are unstable at elevated temperatures and/or high humidity frequently releasing polyiodine from the polymer matrix. To address this drawback, Han et al., “Atactic Poly(vinyl alcohol)/Dye Polarizing Film with High Durability” (2003), International Display Manufacturing Conference, Taipei 18-21, describe a system having improved stability. Instead of iodine, an azo dye (e.g., Direct Blue or Direct Red), is used. While not being bound by theory, it is believed that stability of the film depends on the properties of the dye molecules themselves and their interaction with the polymer base.

Recently, a promising class of water-soluble dichroic organic dyes has been described as optical film materials with planar molecular structures. Heterocyclic molecules and molecular aggregates of such compounds are characterized by a strong dichroism in the visible spectra range. The process for obtaining thin crystal films of these dye materials is described herein below.

In the first stage, a water-soluble dye is allowed to form a lyotropic liquid crystal phase. Yeh et al., “Molecular Crystalline Thin Film E-Polarizer,” Molecular Materials, 14, 2000, describes columnar aggregates composed of discotic molecules of the dichroic dye. Lydon, “Handbooks of Liquid Crystals,” Chromonics, 1998, pp. 981-1007, describes dye molecules capable of aggregating in dilute solutions.

In the second stage, a shearing force is applied to the lyotropic liquid crystal phase (in the form of ink or paste) to align the molecular columns in the direction of the shear. High thixotropy of the liquid crystal ink or paste provides high molecular ordering in the shear induced state and the preservation of the molecular ordering after the shearing action is removed.

In the third stage, evaporation of the solvent, such as, but not limited to, water, leads to crystallization with the concomitant formation of a solid crystal film from the pre-oriented liquid crystal phase, —see, for example, U.S. Pat. No. 6,563,640, which is hereby incorporated by reference. Such Thin Crystal Films (TCFs) possess high optical anisotropy of refraction (e.g., birefringence) and absorption indices making them suitable as polarizers. Polarizers and applications thereof, such as, but not limited to, liquid crystal displays, are described in Bobrov, Yu. A., J. Opt. Tech., 66, 547 (1999), and Ignatov et al., Society for Information Display, Int. Symp. Digest of Technical Papers, Long Beach, Calif., May 2000, vol. XXXI, p. 1102.

In practice, the most frequently encountered type of interactions in polymer-dye systems is the adhesive interaction at the interface. This mechanism underlies the action of aligning polymeric substrates widely used for obtaining oriented layers of various liquid-crystalline dyes, followed by formation of liquid crystal films. The adhesive and aligning properties of polymer films are determined, to a considerable extent, by the ability of these materials, as dielectrics, to retain the polarized (charged) state. However, the strength of interaction between the layers of the dye and polymer is limited and cannot exceed the magnitude of the cohesive forces which determine the strength of each separate component.

Taking into account the low strengths of the bonds between molecular aggregates of dyes and between aggregates and polymers, there exists a need for means for increasing the strength of the interactions in polymer-dye systems.

Tazuke et al., Polymer Letters, 16(10), 525 (1978), and Turner, Macromolecules, 13 (4), 782 (1980) point out [ ] that the optical and mechanical properties of polymers with chemically bound dyes are higher than the analogous properties of mechanical mixtures. However, the formation of covalent bonds is not always readily provided and usually requires introducing appropriate reactive groups into both the polymer and dye, which is at times difficult in the case of dyes.

A method of obtaining films for liquid crystal displays is described in U.S. Pat. No. 5,730,900. According to this method, a film is composed of an oriented polymer matrix and a liquid crystalline compound contained therein.

Ionic type interactions of an ion exchange type between a polymer and a dye was studied in Tkachev et al., Polymethacrylates Containing Immobilized Dye: Optical and Sorption Properties, Vysokomol. Soedin., 1994, vol. 36, no. 8, p. 1326. In this system, dye molecules behave as counterions and are bound to the polymer chains by ionic bonds. An analysis of the optical properties of such polymer-dye systems showed that immobilization of the dye on the polymer in this way makes the system more stable than systems without chemical bonds.

The interaction of molecules of the aforementioned class of water-soluble organic dyes with charged macromolecules of poly(diallylmethylammonium chloride) was studied in Schneider, T., et al., Self-Assembled Monolayers and Multilayered Stacks of Lyotropic Chromonic Liquid Crystalline Dyes with In-Plane Orientational Order, Langmuir 2000, 16, p. 5227. This polymer dissociates in water with the formation of a positively charged polyion and negative chlorine ion (occurring in solution). The substituted amphiphilic dye molecules contain sulfonic groups, which are negatively charged in solution. The resulting ionic (electrostatic) interaction between the surfaces of molecular layers at the polymer-dye interface was used to provide for the self-assembly of orientation-ordered monolayers and multilayer stacks of liquid crystal dyes. In this case, each polymer layer plays the role of the aligning substrate for the adjacent crystalline layers. The resulting self-assembled structure is strongly optically anisotropic strong multilayer material having alternating monolayers of polymer and dye. However, practical applications usually require optical materials functional layers of certain individual thickness. Such layers cannot be obtained using this known method, which is applicable only in liquid media. Thus, there is a need for methods for fabricating polymer-dye systems with thin alternating layers of polymer and dye in a non-liquid media. There exists a need for a method for fabricating polymer-dye systems having certain individual thicknesses for optics.

### BRIEF SUMMARY OF THE INVENTION

The present invention discloses a method of fabricating a two-phase film material possessing high working characteristics. The disclosed method is used to provide two-phase anisotropic film materials of definite thickness and possessing good optical and required mechanical properties.

The aforementioned and other aspects and the advantages of the present invention are achieved by a two-phase film material fabricated by the method comprising: (i) preparing of a lyotropic liquid crystal of supramolecules comprising molecules of organic compounds, comprising at least one polar group; (ii) depositing a layer of the lyotropic liquid crystal (LLC) on the substrate; (iii) applying an external aligning or orienting action to the LCC layer; (iv) removing the solvent to form a layer of crystalline film of supramolecules; (v) treating the film with a solution of a binding agent comprising at least one reactive group that entering into a chemical interaction with the polar groups of the film and following by formation of a polymer phase; and (vi) curing the polymer film phase to form a two-phase film material.

In general, the two-phase film materials of the present invention comprise a first phase comprising supramolecules organized into a crystalline structure, and a second phase comprising a polymer film.

In one contemplated embodiment, the multilayered film material of the present invention comprise more than one alternating first phase comprising supramolecules having a crystalline structure and a second phase comprising a polymer film.

### BRIEF DESCRIPTION OF THE DRAWINGS

The skilled artisan will understand that the drawings, described below, are for illustration purposes only. The drawings are not intended to limit the scope of the present teachings in any way.

FIG. 1A illustrates one contemplated embodiment of the present invention wherein a thin layer of crystalline film has been deposited and dried on a substrate. The crystalline film comprises organic molecules comprising polar groups appending therefrom.

FIG. 1B illustrates the treatment of a crystalline film, representing an ordered system of supramolecules, with a solution of binding agent B in an organic solvent.

FIG. 1C illustrates a two-phase material film comprising a crystalline layer and a polymer layer following the treatment of the crystalline film (representing an ordered system of supramolecules) after curing polymer phase with UV radiation.

FIG. 2 illustrates a multilayered material film comprising alternating layers of a first phase comprising a crystalline film and a second phase comprising a polymer layer

### DETAILED DESCRIPTION OF THE INVENTION

The present invention discloses a method of obtaining optically anisotropic film materials capable of selectively functioning in a broad wavelength range. The functional optical layer is based on various organic substances forming lyotropic liquid crystal mesophases in solution. In one aspect, applying an external orienting action on these lyotropic liquid crystals and removal of the solvent leads to the formation of thin, anisotropic crystalline films comprising ordered systems of supramolecules. These films, however, possess insufficient mechanical strength. In order to improve mechanical strength, the optic films are treated with a binding agent capable of forming a polymer phase in the form of a protective film. The polymer phase imparts mechanical strength without drastically influencing the optical properties of the crystalline films in the working spectral range.

In the present invention, the term “phase” describes the state of matter. Within a particular phase, the matter is homogeneous throughout with respect to both chemical composition and physical state, see, for example, P. W. Atkins, Physical Chemistry, Oxford University Press, 1978, p. 312.

In another aspect, the supramolecules of the present invention are defined as polymeric arrays of monomeric units:molecules of organic compounds, herein known as organic molecules or compounds, having a planar configuration and substituted polar groups, and are brought together by noncovalent bonds such as, for example, but not limited to, π-π (or arene-arene), etc, see, for example, Brandveld, “Supramolecular Polymers, Chem. Rev., 101, 4071-97 (2001).

With respect to their chemical structure, in typical embodiments, these organic molecules are polycyclic compounds including, but not limited to, carbocyclics and/or heterocyclics with conjugated systems comprising π bonds. In alternative embodiments, conjugation can be achieved by the protonation or deprotonation of hydrogen.

In yet another aspect, these organic molecules are substituted with polar groups. In general, the polar groups are hydrophilic and govern the solubility of organic molecules in water and other polar solvents. One class of organic compounds suitable for the present invention includes, but not limited to, organic dyes.

Supramolecules of the present invention comprise polycyclic organic molecules with conjugated π-systems that are interconnected by non-covalent linkages such as, but not limited to, π-π, ionic, van der Waals, Metal-Metal, Metal-π, Metal-π*, Metal-σ, dipole-dipole, coordinative, hydrogen, hydrophobic-hydrophobic or hydrophilic-hydrophilic interactions[see coomment above. These supramolecules can be described as polymeric array of organic molecules with conjugated π-systems in which said molecules, linked by noncovalent bonds, have the general formula:
{M}ₙ(F)_{d}, (1)
where M(monomeric units) is a polycyclic organic molecule capable of entering into chemical interactions with like organic molecules through π-π bonds
n is the number of molecules in the polymeric chain and is up to 10000; F is a polar group exposed to inter-supramolecular space; and d is the number of polar groups per molecule and varies from 1 to 4.

The polar groups can be ionogenic and/or non-ionogenic. Ionogenic polar groups typically include anionic groups of strong mineral acids such as, but not limited to, sulfonic, sulfate boronate, phosphonate and phosphate groups as well as carboxy-groups. In addition, ionogenic polar groups also include cationic fragments such as, but not limited to, protonated amino or imine groups and some amphoteric groups possessing pH-dependent properties. In solution, these polar groups are always accompanied by one or several, like or different, counterions. Polyvalent counterions may simultaneously belong to more than one organic molecule. Non-ionogenic polar groups include, but not limited to, hydroxyl, chlorine, bromine, fluorine, alkoxy, trihaloalkoxy, cyano, nitro, ketones, aldehydes, esters, epoxides, boronate esters, thioester, thiols, isocyanates, isothiocyanates, alkenes, alkynes, and the like.

Specific examples of non-polar groups include, but not limited to, methyl, ethyl, methoxy, ethoxy, etc.

The molecules of organic compounds under consideration in the present invention possess planar configuration, usually of an ellipsoidal shape. These molecules can be either symmetric or asymmetric, with or without substituents arranged at the periphery. In typical embodiments, the organic molecules of the present invention are amphiphilic and may simultaneously contain substituents that are chemically similar or different.

The preferential interaction of the substituent groups with the solvent leads to the formation of an ordered structure of organic cyclic molecules of the same type called a lyotropic liquid crystal (LLC) or a mesophase. A lyotropic liquid crystal is characterized by a phase diagram with a domain of stability over a broad range of concentrations, temperatures, and pH values.

The formation of such lyotropic liquid crystal by the organic substances under consideration in a polar solvent is a condition necessary to achieve the technical result of the disclosed invention. The main polar solvent is water or a mixture of water and a water miscible polar solvent, wherein the water can be found in any proportions in the solvent. In one aspect, the present invention makes use of soluble organic substances capable of forming a lyotropic liquid crystal, for example, see U.S. patent publication U.S.2001/0029638 entitled “Dichroic Polarizer and a Material for Its Fabrication.” Suitable organic molecules include, but not limited to, polymethine dyes (e.g., pseudoisocyanine, piacyanol), triarylmethane dyes (e.g., Basic Turquose, Acid Light Blue 3), diaminoxanthene dyes (e.g., sulforhodamine), acridine dyes (e.g., Basic Yellow K), sulfonated acridine dyes (e.g., trans-quinacridone), water-soluble derivatives of anthraquinone dyes (e.g., Active Light Blue KX), sulfonated vat dye products (e.g., flavanthrone, Indanthrene Yellow, Vat Yellow 4K, Vat Dark Green G, Vat Violet C, indanthrone, Perylene Violet, Vat Scarlet 2G), azo dyes (e.g., Benzopurpurin 4B, Direct Lightfast Yellow 0), water-soluble diazine dyes (e.g., Acid Dark Blue 3), sulfonated dioxazine dye products (pigment Violet Dioxazine), soluble thiazine dyes (e.g., Methylene Blue), water-soluble phthalocyanine derivatives (e.g., copper octacarboxyphthalocyanine salts), fluorescent whiteners, disodium chromoglycanate, perylenetetracaboxylic acid diimide red (PADR), benzimidazoles of PADR (i.e., violet), naphthalenetetracarboxylic acid (i.e., yellow, claret), sulfoderivatives of benzimidazoles and phenanthro-9′,10′:2,3-quinoxaline, etc. In another aspect of the present invention, a method for forming a lyotropic liquid crystal (mesophase), using ionogenic organic molecules in the form of water-soluble sulfoderivatives, comprising individual sulfoderivatives or mixtures or systems of individual sulfoderivatives, is provided.

Depending on the pH, sulfoderivatives may exist as acids, salts or combination thereof. In typical embodiments, counterions include H⁺, NH₄⁺, K⁺, Li⁺, Na⁺, Cs⁺, Ca⁺⁺, Sr⁺⁺, Mg⁺⁺, Ba⁺⁺, Co⁺⁺, Mn⁺⁺, Zn⁺⁺, Cu⁺⁺, Pb⁺⁺, Fe⁺⁺, Ni⁺⁺, Al+++, Ce⁺⁺⁺, La⁺⁺⁺, etc., or mixtures thereof.

When dissolved in water, the molecules of these sulfoderivatives or their mixtures form anisometric (rod-like) aggregates packed like stacked coins. Each aggregate represents a micelle with an electric double layer, while the entire solution represents a highly dispersed (colloidal) lyophilic system. As the solution concentration (i.e., micelle concentration) is increased, the anisometric aggregates exhibit spontaneous ordering (“self-ordering” or “self-assembly”). This leads to the formation of a nematic lyotropic mesophase, whereby the system becomes liquid-crystalline. The high ordering of dye molecules in columns allows their mesophases to be used for obtaining oriented dichroic materials. The films formed from these materials possess a high degree of optical anisotropy. The liquid crystal state is readily verified by usual methods, but not limited to, polarization microscopy.

The content of the sulfoderivative or their mixtures or systems of sulfoderivatives in the lyotropic liquid crystal (mesophase) ranges from approximately 3 to 50 mass %. In some embodiments, the sulfoderivative or mixtures or systems of sulfoderivatives in the LLC ranges from about approximately 7 to 15 mass %. In various embodiments, the mesophase can additionally contain up to about approximately 5 mass % of surfactants and/or plasticizers. By varying the number of sulfonic groups and the number and type of the modifying group or substituents in the discotic dye molecules, it is possible to control the hydrophilic-hydrophobic balance of aggregates formed in liquid-crystalline solutions and to change the solution viscosity. This, in turn, affects the dimensions and shapes of supramolecules, the degree of molecular ordering of the organic molecules, compounds and/or supramolecules, the solubility and stability of the lyotropic liquid crystal.

It should be emphasized that all the aforementioned compounds are capable of forming stable lyotropic liquid crystal in solution as individual sulfoderivatives or as mixtures or systems of individual sulfoderivatives with one another or with some other organic compounds, which are colorless or weakly absorbing in the visible spectral range. After removal of the solvent, these mesophases can form anisotropic crystalline films possessing high optical characteristics.

Suitable methods for concentrating the LLC include evaporation, distillation, flowing an inert gas, heating to a relatively low temperature, vacuum distillation, or combination thereof. This treatment leads to the formation of a paste-like composition (“ink”), which is capable of retaining the liquid crystal state for a sufficiently long time.

Typically, a layer of the lyotropic liquid crystals is formed by applying the solution or concentrate onto a clean substrate surface. The substrates are usually made of glass, polymer, semiconductor, metal, alloys, silicates, some other materials or combination thereof. The substrate can be either hydrophilic or hydrophobic; it can be either planar or possess any other preset shape. The structure of the applied lyotropic liquid crystal layer can be controlled by using aligning substrates of polymeric materials. The aligning properties of polymeric dielectric coatings are provided by the known chemical methods (using polar polymers in the form of polyions, see, for example, U.S. Patent application 2002/0168511 A1) or by physical methods, among which most widely used is the injection of charge carriers into the dielectric material. This is achieved by processing the material with a rubbing roller producing mechanical friction, or by exposure to a corona discharge, or by plasma treatment. The charge carrier injection processes are universal and can be used for the treatment of any polymeric coatings, including films obtained by the disclosed method.

The layer of said lyotropic liquid crystal formed on the substrate is stable for a sufficiently long time, so that the following processing steps can be performed with some delay.

In addition to charge carrier injection methods, there are other known methods of orienting organic molecules externally such as, but not limited to, mechanical, electrical, magnetic, plasma or physical orienting or aligning forces or action as well as those disclosed in U.S. Pat. Nos. 5,739,296; and 6,174,394, and combination thereof. The intensity of the orienting action, which has to be sufficient to orient the kinetic units of supramolecules in the lyotropic liquid crystal mesophase, depends on the properties of the liquid crystalline solution, such as, but not limited to, the nature, concentration, temperature, pH, etc., of the liquid crystalline solution or mixture. The resulting orientation in the LLC instills and governs the optical properties of the materials and articles derived therefrom.

In various aspects of the present invention, the external orienting action directed to the layer of a lyotropic liquid crystal of organic molecules is produced by mechanical shear. Typically, alignment by mechanical shear can be achieved through the use of one or more alignment devices of various types, including, but not limited to, a knife, a cylindrical wiper or a flat plate oriented parallel or at an angle to the surface of the LLC layer. A distance from the surface to the edge of the aligning instrument is set so as to obtain a film of required thickness.

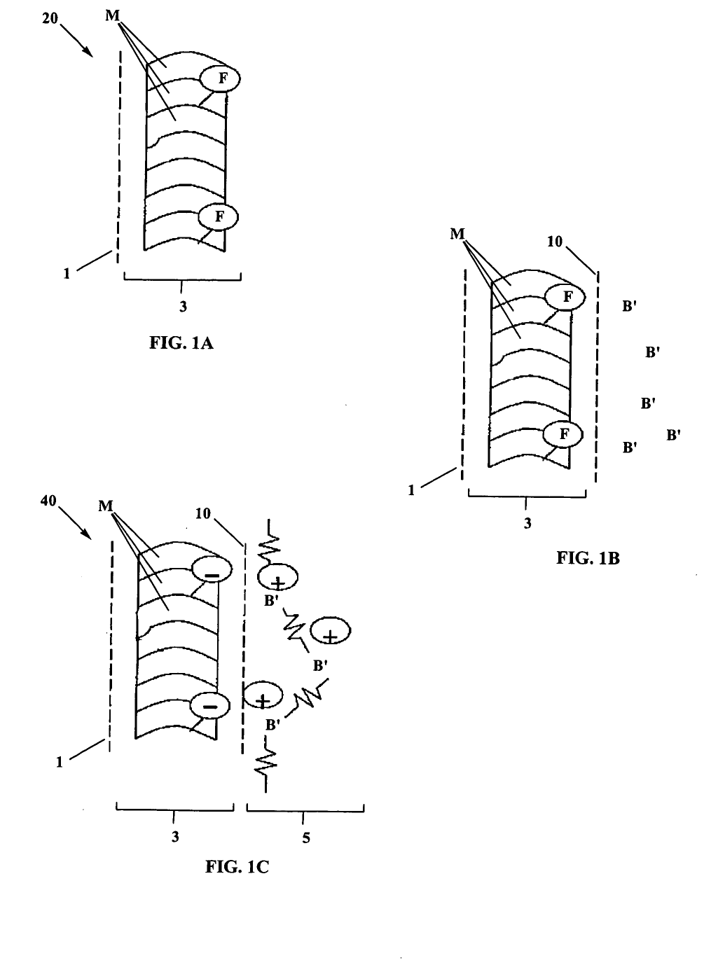

In a series of embodiments, the subsequent removal of solvent is performed under mild conditions at room temperature for a time period up to 1 hour. Alternatively, if permitted, for the sake of saving time, the solvent can be removed by heating in the temperature range from approximately 20 to 60° C. at a relative humidity of approximately 40 to 70%. Now referring to FIG. 1A, this treatment leaves substrate 1 covered by an oriented thin layer of crystalline organic film 3 to yield film-substrate structure 20.

The solvent removal regime has to be selected so as to exclude the possibility of impairing orientation of the previously formed lyotropic liquid crystal structure, while providing for the relaxation of stresses arising in the course of the external orienting action. In most embodiments, the solvent removal step should be performed under conditions of elevated humidity. Important factors for ensuring a high degree of crystallinity in the LLC layer include, but not limited to, rate and directional characteristics of the solvent removal process from the system. The resulting crystalline layer 3 represents a sufficiently thin continuous film possessing a molecularly ordered and arranged structure, in which organic molecules are grouped in orientation-ordered assemblages forming supramolecular assemblages, aggregates, colloids, particles, suspensions or mixtures thereof. The formation of these assemblages and structures result from a special liquid-crystalline orientation of molecules in solution, wherein the assembly already possess a local order by entering into one- and/or two-dimensional mutually oriented quasi-crystalline aggregates. When this quasi-crystalline aggregate solution and/or mixture is applied onto a substrate surface with simultaneous application of an external orienting action, the organic molecules and/or aggregates in solution and/or mixture undergoes macroscopic orientation by self-assembly into a supramolecular complex. This orientation is retained in the course of drying. Drying, in turn, may further enhance molecular ordering due to crystallization. Now referring to FIG. 1A, the resulting crystalline film 3 is shown with at least one substituent F appending therefrom on substrate 1. The crystalline film 3 has an interplanar spacing in the order of 3.4±0.3 Å along one of the optical axes. The film can be birefringent and exhibit dichroic, polarizing, and phase-shifting (retarder) properties related to a difference in refractive indices in the mutually perpendicular directions relative to the optical axis. The film can also possess the properties of an optical filter. The film may combine various properties and perform several functions simultaneously.

Now referring to FIG. 1B, the next stage in fabricating two-phase film materials of the present invention involves treating the solid crystal film 3, possessing an ordered structure of supramolecules, with binding agents, including molecules, macromolecules or oligomers, herein known as binding agent or B, to form a protective polymer film, phase or layer 5, as shown in FIG. 1C, and create a unified physicochemical system 40. The newly formed phase 5 comprising individual binding agent molecules B interact with each other and with the polar groups of the organic molecules or compound at the phase boundary 10. Typically, the rate of the intramolecular chemical interactions between binding agent molecules, is significantly higher than the intermolecular chemical interactions between layers 3 and 5 at phase boundary 10. Now referring to FIG. 1C, if binding agent molecules or monomers are selected such that each binding agent molecule has two different substituents such as, for example, alkene and a polar cationic moiety, binding agent molecules can be intramolecularly polymerized to form a cross-linked polymer layer 5 and intermolecularly bond to the crystal layer 3 by ionic interactions if layer 3 has negative groups such as, but not limited to, sulfonates. In alternative embodiments, binding agent molecules having one reactive group or substitutent can be used. An appropriate charge can be injected or imparted with into the polymer (e.g., charge carrier injection, etc.), or the polymer can be doped with a charge conferring atom (e.g., metals, etc.), ion (e.g., metals, electrolytes, etc.), or compound including linkers (e.g., homobifunctional, heterobifunctional, trifunctional linkers, etc.) to promote interphase crosslink. In selected embodiments, the chemical nature of the binding agent facilitates interphase crosslink by a combination of covalent or non-covalent interactions.

In a series of embodiments, binding agent molecules have more than one reactive group. In certain embodiments, a mixture of different binding agent molecules having different reactive, in particular can be used. In another series of embodiments, binding agent molecules are saturated, partially unsaturated or fully unsaturated aliphatic or aromatic compounds, including heterocyclic compound, and mixtures thereof, having at least one reactive group such as, but not limited to, alkenes, alkynes, amines, hydrazines, alcohols, thiols, ketones, aldehydes, esters, carboxylic acid, acid chlorides, isocyanates, ketenes, isothiocyanates, epoxides, acrylates or thioesters. In alternative embodiments, pre-fabricated polymer, resin, or oligomer films, having appropriate reactive or polymerizing groups appending therefrom, can be deposited to achieve a similar two-phase optic material without undergoing in-situ polymerization on the crystalline film by using preliminarily prepared solutions of polymers, resins, or its oligomers.

In general, reactive groups can be broadly classified as nucleophilic or electrophilic moieties. For each moiety type, it can be further defined as saturated nucleophile/electrophile (e.g., amines, hydrazines, azides, carbon anions, thiols, phosphorus, alcohols, oxyanions, alkyl halides, boronate esters, epoxides, etc . . . ) or unsaturated nucleohile/electrophile (e.g., alkenes, alkynes, allenes, cyano, ketones, aldehydes, esters, carboxylic acids, acrylates, ketenes, isocyanates, acyl chlorides, sulfonyl chlorides, phosphorylchlorides, phosphonoamides, isothiocyanate, thiocyanates, thioketones, etc. . . . ).

Other examples of suitable reactive groups and polymerizable reactions can be found in Hermanson, G. T., Bioconjugate Techniques, Academic Press, Inc., San Diego, Calif. (1996), incorporate herein by reference in entirety.

In typical embodiments, the binding agent molecules or monomers can be initiated and/or polymerized by a radical reaction, a condensation reaction, an ionic interaction, or combinations of reactions thereof, involving covalent bonds and/or non-covalent bonds.

In one aspect, the polymerization reactions and conditions are selected to yield films that are structurally homogeneous and minimally influence or disrupt the optical properties of the thin crystal film 3.

In another aspect, the chemical reaction, usually polymerization reactions by an ionic type mechanism, can be initiated by protons, hydroxides or metal cations, including alkaline, alkali, metallic, organic, inorganic, transition, earth metals or rare earth metals, or combination thereof, playing the role of counterions for the polar groups in organic film 3.

The polymerization process can be initiated by heating, UV radiation, or chemical interaction, for example with the same counterions. The polymerizing compounds (i.e., binding agents) may contain catalysts corresponding to the reaction type such as, for example, catalysts for curing resins In particular embodiments, binding agents for the UV-initiated processes may contain photosensitizers such as, but not limited to, ketones, benzophenone, etc., in an amount of up to approximately 0.5%. Optionally, radical polymerization can be initiated thermally with or without chemical initiators such as, but not limited to, benzoyl perioxide or N-oxides.

Suitable binding agent, molecules or monomers of the present invention include epoxy resin and methyl methacrylate.

In another aspect, the polymer films may account for up to approximately 10 to 60 mass % of the system. The binding agent may contain various modifying additives, either separate or in mixtures (e.g., plasticizers such as dibutylphthalate for improving the film properties) with a total content of up to approximately 20 mass %. The degree of polymerization is above 40 for aromatic monomers and above 120 for aliphatic monomers, which ensures the formation of high-molecular-weight polymers having high mechanical properties as protective films. The length of macromolecules has to be not shorter than the interstack distance (40-100 Å) between dye columns.

In yet another aspect, the molecular weight distribution of the synthesized polymers range from approximately 4000 to 20000. In some embodiments, the distribution falls within approximately 5000 to 8000. Although the molecular weight distribution of the polymer can be significantly greater, for example, by a factor of ten or more, this however complicates the formation of high-quality films.

In some embodiments, depending on the polymer structure and preparation conditions, the film can be crystalline or partly crystalline. In other embodiments, the film thickness for each of the two phases are comparable, being typically in the range of approximately about 0.1 to 2.0 microns.

The final stage of fabricating two-phase film materials of the present invention is curing of the polymer film, in the course of which, the required two-phase material is obtained. In some embodiments, this process can be carried out in various ways depending on the particular polymer. In typical embodiments, curing can take place at elevated temperatures above 100° C. with an exposure time in the range of approximately about 10 minutes to 10 hours. In other embodiments, “cold curing” or room temperature curing under UV irradiation can be employed.

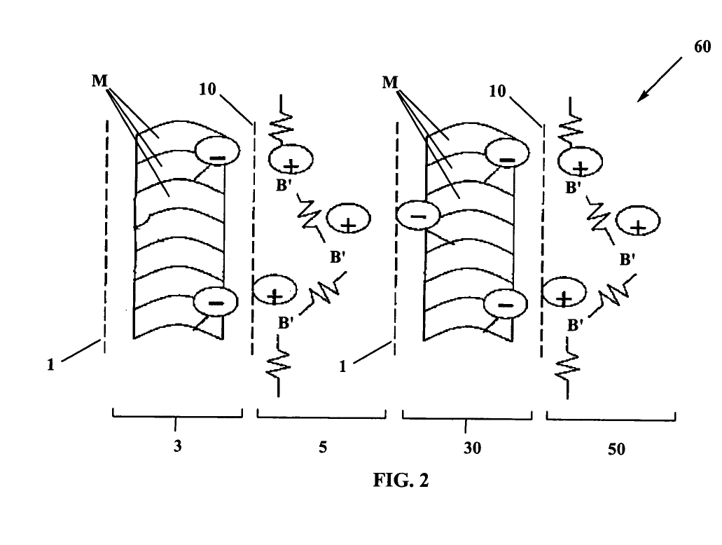

In one aspect, the present invention can be used for the obtaining multilayer film materials. Now referring to FIG. 2, the two-phase material serves as a substrate for the formation of a second lyotropic liquid crystal layer 30 in process of fabricating multilayered materials 60. The layer of lyotropic liquid crystal 30 is formed on the surface of the substrate according to the above-described method and exemplary embodiments of the present invention. The lyotropic liquid crystal can be the same as layer 3 or different. In some embodiments, the two-phase film material may serve as an aligning substrate for the lyotropic liquid crystal layer formation and influence the crystallization process. In other embodiments, the alignment of the substrate is made by the application of an external action such as mechanical alignment and/or shear, by application of an electric field, by treatment with plasma or combinations of any external forces able to direct organic molecules, supramolecules or LLCs described herein. Following the deposition of LLC layer 30, a second binding agent or polymer layer 50 can be added by depositing a pre-fabricated film comprising polymers, resins, oligomers, block co-polymers, dyes, additives, surfactants, metals, plasticizers, or mixtures thereof. Alternatively, the second polymer layer 50 can be generated from a polymerization reaction described herein, such as, but not limited to, covalent reaction (e.g., radical polymerization, condensation reaction, etc . . . ), non-covalent reaction (e.g., ionic, π-π, van der Waals, Metal-Metal, Metal-π, Metal-π*, Metal-σ, dipole-dipole, coordinative, hydrogen, hydrophobic-hydrophobic or hydrophilic-hydrophilic interactions) or combination thereof. Regardless of the technique used to introduce polymer layer 50, the polymer can be the same as layer 5 or different. Advantageously, in various embodiments, the fabricated material, film or layers can be controlled to any predetermined and desired thickness.

The foregoing description of the embodiments of the invention has been presented for the purpose of illustration and description. They are not intended to be exhaustive or to limit the invention to the precise forms disclosed, and obviously many modifications, embodiments, and variations are possible in light of the above teaching. It is also intended that the scope of the invention be defined by the claims and Examples appended hereto and their equivalents.

### EXAMPLES

The examples described below are presented for illustration purposes only, and are not intended to limit the scope of the present invention in any way.

### Example 1

### Preparation of a Two-Phase Film Material

In the first step, a crystalline film of organic molecules is prepared. Distilled water is added to a flask with 10.0 g of sulfonated naphthoylene benzimidazole. The mixture is stirred with heating until complete dissolution. The final solution concentration is approximately about 7 to 15 mass % and, if necessary, excess water can be distilled off at a reduced pressure. Then the concentrate is applied onto a glass substrate. After the appearance of a liquid-crystalline mesophase, the film is ordered by moving an upper glass plate, which serves as an aligning instrument, relative to the lower glass substrate coated with the LLC film. Finally, the film is dried at a temperature of approximately 20° C. and at a relative humidity of 65%. The film has a thickness of about 0.5 μm and exhibits anisotropic optical properties.

A high-molecular-weight epoxy resin is synthesized as follows. A round-bottom flask equipped with a mechanical stirrer, thermometer, and reflux condenser is charged with 24.5 g of xylene and 16.7 g of an epoxy resin (DER-300), and the mixture is heated with stirring to about 120° C. Then, 10.0 g of bisphenol A and 0.04 g of 2-methylimidazole (i.e., curing catalyst) are added and polymerized by heating the mixture to reflux (i.e., 142-144° C.) until a highly viscous solution is obtained. Finally, the mixture is diluted with ethyl cellosolve (on cooling to about 120° C.) and methyl ethyl ketone (on cooling to about 80° C.) in a 1 to 5 ratio until a final resin concentration of 8-10% in the solution in achieved. The polymer has a molecular weight of 15000 and the residual content of epoxy groups is 0.4%.

The crystalline film of organic molecules on the substrate is immersed for 2 to 3 seconds into the epoxy resin solution. The substrate sample is then carefully lifted up in a vertical position. The obtained transparent film is dried in air at room temperature for approximately 30 min, and then at about 150° C. for 15 min. The final two-phase film material has a thickness of approximately about 1 μm. The crystalline film structure and the polymer film quality were studied using a polarization microscope. The formation of interphase crosslinks were confirmed by IR spectroscopy. The two-phase film material exhibited anisotropic optical properties.

The spectra of the sample of two-phase film materials were measured using Ocean PC 2000 and Cary 500 (Varian) spectrophotometers in the range of 400 to 700 nm. The spectral characteristics of the film resembled the spectra for the individual layers as manifested by the characteristic absorption bands in the region of 500, 560, and 660 nm.

The optical properties of the film are provided below in Table 1.

TABLE 1

| | Transmittance, % | | | | | |
|---|---|---|---|---|---|---|
| Sample | T | H₀ | H₉₀ | Ep | CR | Kd |

Calc. with CIE-Photopic Illuminant C

| | | | | | | |
|---|---|---|---|---|---|---|
| Without coating on top (Film | 88.02 | 77.69 | 77.27 | 5.2 | 1.0 | 2.3 |
| Thickness: approx. about 0.5 μm) | | | | | | |
| With coating on top (Film | 87.97 | 77.50 | 77.28 | 3.7 | 1.0 | 1.8 |
| Thickness: approx. about 1.2 μm) | | | | | | |

Here, T, H₀, and H₉₀ are the characteristics of transmission of the non-polarized and polarized (parallel and perpendicular) light, respectively. E_{P} is the polarization efficiency, CR is the contrast ratio and K_{d} is the dichroic ratio. The ultimate bending strength of the film was 40 Mpa.

### Example 2

### Preparation of a Two-Phase Film Material

In the first step a crystalline film of organic molecules is prepared. Distilled water is added to a flask with 8.0 g of a mixture of sulfonated dyes including indanthrone, Perylene Violet, and Vat Red 14 in a ratio of 5:1:2. The mixture is stirred with heating until complete dissolution. The final concentration of the solution is 10%. If deemed necessary, excess water can be distilled off at a reduced pressure to achieve the appropriate concentrate. The concentrate is then applied onto a glass substrate. After the appearance of a liquid-crystalline mesophase, the film is ordered by moving an upper glass plate that serves as an aligning instrument relative to the lower glass substrate coated with the layer of LLC. Finally, the film is dried at a temperature of about 20° C. and at a relative humidity of 70%. The film has a thickness of approximately about 0.4 μm and exhibits anisotropic optical properties.

The substrate coated with the film is immersed for 3 to 4 seconds into a 5 to 6% solution of poly(methyl methacrylate) (mol. weight, 8000) in a monomer containing 0.037 g (0.5% solution) of a photoinitiator (e.g., benzophenone) and 0.015 g (6% solution) of tert-butylmercaptane (e.g., a molecular weight regulator). The sample is removed from the polymer solution/mixture, and subsequently exposed for 15 min to UV radiation. The sample is then dried for 2 h in air at room temperature.

The optical properties of this film are provided below in Table 2.

TABLE 2

| | | | | | | | Color coordinates | | | | | |
|---|---|---|---|---|---|---|---|---|---|---|---|---|
| | Transmittance, % | | | | | | Single | | Two parallel | | Two crossed | |
| # | T | H₀ | H₉₀ | Ep | CR | Kd | A | B | a | B | A | B |

Initial

| | | | | | | | | | | | | | |
|---|---|---|---|---|---|---|---|---|---|---|---|---|---|
| 0.4 μm | 6 | 36.2 | 25.7 | 0.4 | 98.3 | 58.6 | 15.3 | −1.80 | 0.66 | −4.62 | 4.43 | 12.79 | −25.93 |

After post-treatment

| | | | | | | | | | | | | | |
|---|---|---|---|---|---|---|---|---|---|---|---|---|---|
| 1.0 μm | 6 | 34.2 | 23.1 | 0.3 | 98.8 | 66.1 | 14.8 | −2.19 | 1.70 | −4.71 | 5.18 | 11.55 | −23.24 |

Here, T, H₀, and H₉₀ are the characteristics of transmission of the nonpolarized and polarized (parallel and perpendicular) light, respectively. E_{P} is the polarization efficiency, CR is the contrast ratio and K_{d} is the dichroic ratio. The final film has a thickness of approximately about 1.0 microns and an ultimate bending strength of 40 Mpa.

The experimental data above shows that the interphase interaction between the binding agent and the solid film comprising a system of ordered organic molecules affords, together with other operations, strong homogeneous films of controlled thickness possessing at least the same optical properties as those of the individual initial films.

1. A method of fabricating a two-phase film material, comprising the steps of preparing a lyotropic liquid crystal in a polar solvent comprising supramolecules comprising molecules of an organic compound, wherein each molecule comprises at least one polar group;
depositing a layer of the lyotropic liquid crystal on a substrate;
applying an external orienting action;
removing the solvent to form a crystalline film of supramolecules;
treating the film with a binding agent comprising at least one reactive group followed by formation of a polymer phase and a chemical interaction of said reactive groups with polar groups of the film; and
curing of the polymer film phase to form the two-phase film material.

2. The method of claim 1, wherein preparing the lyotropic liquid crystal comprises concentrating a solution of the organic compound.

3. The method of claim 2, wherein the content of the organic compound is in the range of approximately 3 to 50 mass %.

4. The method of claim 3, wherein the content of the organic compound in the lyotropic liquid crystal is in the range of approximately 7 to 15 mass %.

5. The method of claim 1, wherein said polar solvent is water.

6. The method of claim 1, wherein said supramolecule is a polymeric array of organic molecules with conjugated π-systems in which said molecules, linked by noncovalent bonds, have the general formula:
{M}ₙ(F)_{d}
where M is a polycyclic organic molecule that is linked with other polycyclic organic molecules through π-π bonds[; n is the number of the organic molecules in the polymeric chain and has value of up to 10,000; F is a polar group exposed to intersupramolecular space; and d is the number of polar groups per the organic molecule and varying from 1 to 4.

7. The method of claim 6, wherein the polar groups are ionogenic and ensure the solubility of the organic molecules in the polar solvent for the formation of the lyotropic liquid crystal.

8. The method of claim 7, wherein the polar groups are associated with one or more counterions.

9. The method of claim 1, wherein the lyotropic liquid crystal further comprising up to approximately 5 mass % of surfactants.

10. The method of claim 1, wherein the lyotropic liquid crystal further comprising up to approximately 5 mass % of plasticizers.

11. The method of claim 1, wherein said external orienting action is mechanical shear.

12. The method of claim 1, wherein said external orienting action is electric or magnetic field, or combinations thereof.

13. The method of claim 1, wherein said external orienting action is applied simultaneously or separately with the deposition of the lyotropic liquid crystal layer.

14. The method of claim 1, wherein the polar solvent is removed at a temperature between approximately 20° C. and 60° C. and at a relative humidity of approximately 40 to 70%.

15. The method of claim 1, wherein the polar solvent is removed at a temperature of approximately 20° C. over a time period of up to approximately 1 hour.

16. The method of claim 1, wherein the chemical interaction of reactive groups of said binding agent with the polar groups of the supramolecules does not disturb the crystalline film of supramolecules.

17. The method of claim 16, wherein the binding agent comprises at least one polymer.

18. The method of claim 17, wherein the polymer comprises a resin.

19. The method of claim 16, wherein the binding agent comprises at least one aliphatic or aromatic monomer.

20. The method of claim 17, wherein the binding agent further comprising at least one aliphatic or aromatic monomer.

21. The method of claim 17 or 19, wherein the binding agent comprises up to approximately 0.5 mass % of a photosensitizer.

22. The method of claim 19, wherein the monomer is an unsaturated compound.

23. The method of claim 19, wherein the monomer has at least one nucleophilic reactive group.

24. The method of claim 19, wherein the monomer has at least one electrophilic reactive group.

25. The method of claim 21, wherein the binding agent is an unsaturated or saturated compound.

26. The method of claim 22, wherein formation of the polymer phase proceeds by a radical mechanism.

27. The method of claim 25, wherein formation of the polymer phase proceeds by a radical mechanism.

28. The method of claim 23, wherein formation of the polymer phase proceeds by a condensation mechanism.

29. The method of claim 24, wherein formation of the polymer phase proceeds by the ionic mechanism.

30. The method of claims 17 or 19, wherein formation of the polymer phase proceeds by a combined mechanism.

31. The method of claim 26, wherein formation of the polymer phase is initiated thermally.

32. The method of claim 30, wherein formation of the polymer phase is initiated thermally.

33. The method of claim 26, wherein formation of the polymer phase is initiated by a chemical interaction.

34. The method of claim 28, wherein formation of the polymer phase is initiated by a chemical interaction.

35. The method of claim 29, wherein formation of the polymer phase is initiated by a chemical interaction.

36. The method of claim 30, wherein formation of the polymer phase is initiated by a chemical interaction.

37. The method of claim 35, wherein formation of the polymer phase is initiated by counterions associated with the polar groups of the organic molecules.

38. The method of claim 27, wherein formation of the polymer phase is initiated by UV radiation.

39. The method of claim 30, wherein formation of the polymer phase is initiated by UV radiation.

40. The method of claims 17 or 19, wherein the interaction of the binding agent with the polar groups of the supramolecules is catalyzed by counterions of the polar groups.

41. The method of claim 1, wherein the polymer phase is cured at a temperature above approximately 100° C.

42. A two-phase film material comprising
a first phase comprising a crystalline film of supramolecules comprising at least one polar group and
a second phase comprising a polymer film.

43. The two-phase film material of claim 42, wherein said material is anisotropic.

44. The two-phase film material of claims 42 or 43, wherein said crystalline film has a crystalline structure with an interplanar spacing of 3.4±0.3 Å along one of the optical axes.

45. The two-phase film material of claim 42, wherein the film material is not less than 40 mass % of the first phase.

46. The two-phase film material of claim 42, wherein the polymer phase is formed from aromatic monomers and has a degree of polymerization above 40.

47. The two-phase film material of claim 42, wherein the polymer phase is formed from aliphatic monomers and has a degree of polymerization above 120.

48. The two-phase film material of claim 42, wherein the polymer phase has a molecular weight distribution ranging from approximately about 4,000 to 20,000.

49. The two-phase film material of claim 48, wherein the polymer phase has a molecular weight distribution ranging from approximately about 5,000 to 8,000.

50. The two-phase film material of claim 42, wherein the polymer phase in the film material contains plasticizers in the range of approximately 1 to 20 mass %.

51. The two-phase film material of claim 42, wherein the film material is polarizing.

52. The two-phase film material of claim 42, wherein the film material is a retarder or light filter.

53. The two-phase film material of claim 42 wherein the two-phase material is formed by the method of claim 1.

54. The two-phase film material of claim 42, wherein the film material comprises more than one crystalline film and more than one polymer film.

55. The two-phase film material of claim 54, wherein the film material comprises at least one alternating layer of the crystalline film and/or the polymer film.

56. The two-phase film material of claim 42, wherein the film material serves as a substrate for fabricating a multi-layered film material having more than one alternating layer of the first and/or the second phase.

57. The two-phase film material of claim 56, wherein the substrate serves as an aligning substrate for the deposition of the lyotropic liquid crystal layer.

58. The two-phase film material of claim 56, wherein the substrate is aligned by an external orienting action applied onto the surface by mechanical method or application of electric or magnetic field, or treatment in plasma.
